(19) United States
(12) Patent Application Publication
(10) Pub. No.: US 2004/0249503 A1
(43) Pub. Date: Dec. 9, 2004

(54) Enhanced pin-based security system

(76) Inventor: Bernardo Nicolas Sanchez, Toronto (CA)

Correspondence Address: MARKS & CLERK, 1075 NORTH SERVICE ROAD WEST, SUITE 203, OAKVILLE, ON, L6M 2G2, CA

(21) Appl. No.: 10/492,174

(22) PCT Filed: Jul. 29, 2002
(86) PCT No.: PCT/CA02/01179

(30) Foreign Application Priority Data
Oct. 9, 2001 (CA) 2,358,753

(51) Int. Cl. G06F 17/00

(52) U.S. Cl. 700/237

(57) ABSTRACT

An enhanced system for the security of PIN-based security systems is described wherein the user is provided with a PIN modifier which is specific to a particular transaction. After a successful transaction, the user is provided with a new PIN modifier to use for the next transaction, preferably through the use of an Internet enabled cellular telephone. In order to use the system and gain access to the restricted resources, the user must have the account number, the standard PIN number, and additionally know the PIN number modifier. As a result, increased security for PIN number-based security systems is enhanced.

### FIELD OF THE INVENTION

The present invention generally relates to bank cards, credit cards, debit cards, and the like, and, more particularly, to any such cards or systems which are protected through the use of Personal Identification Numbers (PIN).

### BACKGROUND OF THE INVENTION

Currently there is a widespread use of various types of cards and systems which utilize a Personal Identification Number, which is commonly referred to as a PIN number, to provide security to the cards, by restricting access to the funds or systems related to the cards and/or systems. These cards include, but are not limited to, bank cards, credit cards, debit cards, smart cards, communication cards, financial institution transaction cards and the like, and to non-card systems such as Internet and Intranet access codes, computer codes, alarm codes, lock codes, wireless codes, or any other system which utilizes a PIN number as part of the security system controlling access to the system.

PIN numbers typically comprise 4 to 8 numbers but can comprise fewer or more digits depending oil the user. The PIN number can also comprise alpha-numeric sequences of upper and lower case letters and numbers in combination. While longer, alpha-numeric sequences are preferred in order to reduce the possibility of guessing or theft of the PIN number, and thus gaining access to a restricted system, it can be difficult to remember long complex alpha-numeric codes. Accordingly, PIN numbers are commonly a series of 4 to 8 numbers which must be entered in a specific order.

Use of numeric PIN access codes is particularly true of devices currently termed as “debit cards” wherein a credit card-like card is used which allows for direct access to the bank account of a user to transfer funds from the purchaser to the seller, without use of any credit facilities. Control of the use of the card is provided by having the user enter a PIN number at the point of purchase (or point of sale). As such, debit card readers (or even credit card readers, or the like, requiring a PIN number) with attached numeric keypads are commonly found at retail outlets which permit the user to “swipe” the debit card, and then enter their PIN number to complete the transfer of funds.

Unfortunately, if the account number of the user is known, and it is commonly known from the vendor's transaction receipt, then a potential thief merely requires the user's PIN number. An observant thief can easily determine a user's PIN number by watching the user enter the PIN number. This is particularly true if the user's PIN number is relatively short, such as, for example, only 4 digits long. With this information, the thief can have unrestricted access to the financial or other systems of the user.

Various systems have been proposed to improve security related to debit card systems, and the like. For example, a discussion of proposed PIN access code security systems, and the like, is presented in U.S. Pat. No. 6,246,769 (Kohut), issued Jun. 12, 2001, the contents of which are incorporated herein by reference. While these systems can provide some improvement over the current debit card, PIN number security practices, many do not provide the desired effect while continuing to use the card readers and keypads of the vendor debit card readers currently in wide-spread use.

Accordingly, it is an object of the present invention to provide an enhanced PIN number based security system, and in particular, to provide an enhanced PIN number based security system which can utilize the vendor debit card readers currently in use.

### SUMMARY OF THE INVENTION

The foregoing objects of the present invention are fully or at least partially attained by providing a PIN number security system utilizing an individual PIN number, a PIN number modifier, and a system for notifying a user of the PIN number modifier. For reference, the term “PIN” is used to describe a personal identification number, but may also be a password or a passcode for other security systems.

Preferably, the PIN modifier is provided to the user so that the PIN modifier is changed for each transaction of the user. More preferably still, the user is notified of preferably each transaction, and provided with the next PIN modifier through an separate information transmission device.

Accordingly, the present invention provides an enhanced method for verifying the identification of an authorized user of a set of protected resources within an employed system during a transaction, by utilizing a password, a passcode or a personal identification number, hereinafter collectively referred to as a PIN number, comprising:

providing a user with access to a set of protected resources through an account number;

establishing a standard PIN number related to said account number to limit access to said protected resources to only an authorized user;

providing said user with at least one PIN modifier code through an information transmission device;

creating a correct modified PIN number by applying said PIN modifier code to said standard PIN number;

verifying the authenticity of a PIN number entered when said user attempts to gain access to said set of protected resources in order to conduct a transaction by removing said PIN modifier code from the entered PIN number in order to created an entered, standard PIN number;

authorizing said transaction if said entered, standard PIN number agrees with said standard PIN number, and thus establishing that a successful transaction attempt has been completed;

amending said PIN modifier code after a successful transaction attempt has been completed to a new PIN modifier code; and, providing said user, when necessary, with at least one new PIN modifier code, through said information transmission device, for use in subsequent transaction attempts.

In a further aspect the present invention also provides an enhanced system for verifying the identification of an authorized user of a set of protected resources within an employed system during a transaction comprising:

an account number reader for reading an account number;

a PIN number reader for reading an inputted PIN number;

a system for relating said PIN number to said account number to determine whether a correct PIN number has been entered into said reader; and

a PIN number modification system comprising:

a PIN modifier code generator which provides a PIN modifier code to said user through an information transmission device in order to create a modified PIN number;

a PIN number adjuster to remove the effects of said PIN modifier code from said inputted PIN number to generate an entered, standard PIN number;

a PIN number verifier to compare said entered, standard PIN number to a standard PIN number associated with said account number, and to confirm whether said entered, standard PIN number is the same as said standard PIN number, and thus, authorizing user to conduct said transaction.

Preferably, the PIN modifier code generator provides the user with a new PIN modifier code after each successful transaction.

### DETAILED DESCRIPTION OF THE INVENTION

The basic, standard PIN number used by the user will preferably remain constant from transaction to transaction. Accordingly, the user need only remember one PIN number for a particular account, or for a series of accounts. As is known in the prior art, the PIN number can vary in length, but is preferably at least 4 digits in length, and is preferably between 4 and 8 digits. The PIN number is preferably strictly numeric, in order that existing numeric keypad type access control devices can continue to be used. However, for access to systems using other devices, such as a computer keyboards and the like, alpha-numeric PIN number characters might be used.

The PIN number may be established by the controller of the protected resources, or their agents, but may also be a personalized PIN number established by the user.

The user is preferably notified of the PIN modifier code using an information transmission device separate from said account number information. The information transmission device is kept separate from the account information for security reasons so, for example, if a debit card is lost, anyone finding the card would not be able to use it because they would not have access to the standard PIN number or to the PIN modifier code. Even if the standard PIN is number compromised, the PIN modifier code (hereinafter the “PIN modifier”) would not be known, and thus, an unauthorized user would not be able to gain access to the protected resources.

The information transmission device may be any means which can be used to notify the user of the new PIN modifier, and may be, for example, a device such as a standard telephone through which the user can obtain a new PIN modifier. Other devices might include, for example, an electronic messaging system such as computer electronic mail or some other Internet-enabled device, or a pager device. Preferably the device is an Internet enabled cellular telephone, a personalized digital assistant (PDA), or generally any device which can gain access to an Internet connection or to an IVR (interactive voice response) application, SMS (Short Messaging Service), or the like.

Most preferably, however, the information transmission device is an Internet enabled cellular telephone. This option will be used to describe further variations in the system of the present invention, but it will be clear to the skilled artisan that the other information transmission devices described hereinabove can be utilized. A preferred advantage of using an Internet enabled cellular telephone, is that the user can be notified of new PIN modifiers essentially immediately after the debit card, or the like, is used. Thus, for example, if the user wishes to use a debit card for several purchases it is not necessary to find and use a standard telephone between transactions in order to obtain the new PIN modifier.

Alternatively, the system can be arranged so that the user can obtain multiple PIN modifiers at a given time, in order to reduce the need for updates after each transaction. For example, if a user knew aware that they were going to be in an area where access to cell phone technology was not available, the user could request, for example, the next two, five or ten PIN modifiers, and would be informed of the order in which they were to use the PIN modifiers.

The user might also request that a set number of PIN modifiers is sent after each set has been used. For example, the user may wish to receive 3 new PIN modifiers after using the last set of three modifiers. These numbers might be memorized, but might also be written down, or recorded on the information transmission device used to access the system.

The PIN modifier is preferably an instruction to add at least one additional number to the user's standard PIN number. This could be done, for example, by instructing the user to add the additional number(s) to the beginning (B), middle (M), or end (E) of the standard PIN number to create a “BME” modification system. This BME system will be described hereinbelow in detail.

By adding numbers to the standard PIN number, the security of the system is enhanced in that an unauthorized user is less likely to be able to correctly guess the correct PIN number for a particular transaction. This is even less likely to occur since the correct modified PIN number will change for each transaction. Accordingly, even if an unauthorized user was aware of the last correct PIN number (or even in possession of the user's standard PIN number), and was in possession of the user's account number, they would be unable to use the card since the next correct PIN number would be unknown to the unauthorized user.

Also, since the number of digits used for the correct PIN number can change from transaction to transaction, making guessing of the correct modified PIN number unlikely, and therefore, making unauthorized use of the resources of the owner less likely.

It should be noted that the current system requires an authorized user to be aware of three sources of information in order to complete a transaction. These are the account number (which may be contained on a debit card, credit card, ATM card, or the like), the standard PIN number, and the PIN modifier. If an unauthorized user has only two pieces of information, they will be unable to use the resources of the authorized user.

As a further security feature, the system could be enabled to provide an authorized user with information related to various transactions. These “alerts” could be notification to the user's cell phone, or other Internet enabled device, for example, of any successful transactions, or of any attempts to use the user's resources where the attempt has failed due to the incorrect entry of an invalid PIN number.

The protected resources of the user within an employed system can be any information or financial accounts of the authorized user, and might include, for example, access to the financial accounts of the user including bank cards, ATM cards, debit cards, smart cards, credit cards, prepaid cards, or the like, or any records available to the public where access is controlled by a PIN number system. This could include, for example, financial records, stock market information, investment information, corporate information, insurance records, medical records, and the like. Also, the system could be used to restrict access to any computerized system where a PIN number, or other password system is required, including access to Internet or Intranet systems, electronic mail systems, network login, telephone systems, airline or other reservation systems, or the like. In general, the system is applicable to any system wherein a passcode is required, but is particularly applicable to a PIN number access control system, and is even more particularly relevant to a PIN number access controlled debit card system for retail transactions. ~The “BME” System

A variety of systems can be used to modify the standard PIN number. For example, a user could be instructed to omit various numbers, insert a number depending on the day of the week in a certain location of the PIN number, repeat certain digits of the PIN number, adjust the PIN number depending on the price range of the purchase, or the like. However, a easy to remember system would be desirable in order that the user does not need to remember a complicated system of PIN number modifiers.

A preferred PIN number modification system is a BME system wherein the user is instructed to insert a particular digit or digits at the beginning (B), middle (M), or end (E) of the standard PIN number. Combinations of these modifiers could also be used.

For example, if the user's standard PIN number was “4567”, and the user was given a BME modifier code of “B12” then the user would enter a PIN number of “124567” in order to correctly access the protected resources. Similarly a PIN modifier code of “E23” would result in a correct PIN number entry of “456723”. A PIN modifier code of “M9” would result in one correct PIN number entry of “45967”. It should be noted with a middle (M) code the user might be able to add the added digits to any location within the standard PIN number. The PIN number validation system would, however, need to be aware that several possible PIN codes might be entered, and adjust accordingly.

Combinations of the BME codes could be given, such as “B1,E5” which would result in a correct PIN number entry of “145675”.

Alternative methods for achieving a similar code would be to provide the user with a more graphic representation, such as, for example a code of “**3**” which would instruct the user to insert a 3 after the first two digits of the standard code, or “9****” which would instruct the user to start the code with the digit “9”.

For further reference, additional BME codes, and their resultant PIN number entries, are shown in Table 1. Further, while the PIN number system shown has concentrated on numeric values, it should be clear to the skilled artisan that alpha-numeric characters can also be used when an alpha-numeric keypad is available.

TABLE 1
“BME” Codes-Standard PIN number of “1234”

| | | Correct PIN |
|---|---|---|
| BME Code | Description | number Entry¹ |
| B5 | Begin PIN with digit “5” | 51234 |
| B7E7 | Begin and end with digit “7” | 712347 |
| E3 | End with digit “3” | 12343 |
| B11E99 | Begin with “11” and end with “99” | 11123499 |
| M55 | Insert “55” anywhere in the middle | 155234, or |
| | | 125534, or |
| | | 123554 |
| M(3)2 | Insert “2” after the third digit | 12324 |
| B9M(1)8 | Begin with “9” and insert “8” after | 918234 |
| | first digit of standard PIN | |
| M(1)88,(3)99 | Insert “88” after first digit, and | 18823994 |
| | “99” after third digit of standard PIN | |
| M(2)0,(3)8,E99 | Insert “0” after the second digit, | 12038499 |
| | “8” after the third digit of standard | |
| | PIN and end with “99” | |
| ***9* | Insert “9” after the third digit | 12394 |
| 5**** | Begin with “5” | 51234 |
| B@ | Begin weith the alpha-numeric char- | @1234 |
| | acter “@” | |
| EaH& | End with the alpha-numeric char- | 1234aH& |
| | acters “aH&” | |

¹Added digits shown in bold

A particularly important feature of the present system is that the system can be incorporated into existing systems, with little or no additional hardware being required, and in particular, with little or no additional hardware being required by the retailer, or the user (other than, for example, an Internet-enabled cell phone, which devices are becoming increasing more available, and widely used).

In a preferred system the modified PIN codes would be verified using a system connected to existing protected resource control systems, wherein the protected resource controller (e.g. a financial institution) would identity the user through the account number, determine whether the user was a client using the PIN modifier system, capture the PIN number entered, forward the information collected to a separate system which would identify the current PIN number modifier in place for that client, modify the PIN number entered to remove the digits added as a result of the PIN number modifier, and thus, create an entered standard PIN number of that user, and supply the protected resource controller with the account number and the entered, standard PIN number. The protected resource controller would then examine its own records to determine whether the entered, standard PIN number is, in fact, the correct standard PIN number associated with the account number.

The outcome of the attempt (whether successful or unsuccessful) would be preferably transmitted to the user in order that they would be notified of the use of the system (e.g. an “alert”). Once a successful transaction had been completed, the PIN number modifier system would provide the user with the next PIN modifier code, if the user has used all of the PIN modifiers previously provided.

It should also be noted, that the system might be modified from time to time by the user to address various situations. For example, the user might choose to “freeze” the BME code at a set code in a situation where they will not have access to a system where they can receive new PIN number modification codes.

Additionally, the user might allow a variation where the standard PIN number is used for financial transactions of less than a certain value (e.g. $25) so that small items can be purchased without needing, or using the PIN modifier.

Further, the user might allow a variation wherein a set series of PIN modifiers could be recycled so that the same set of PIN modifiers could be used repeatably. The PIN number modification system might also just provide the user with instructions to use a particular number of the PIN modifier set, or to cycle through the set in a particular order.

The user and/or protected resource holder might also impose a time limit on the use of the PIN modifier, or on some value. For example, the user might be able to lock in a particular set of PIN numbers for a time period of one week, or instruct the user to use a new PIN modifier if the old PIN modifier has not been used for a set period of time.

### BRIEF DESCRIPTION OF THE DRAWINGS

Various embodiments of the enhanced PIN number authorization system of the present invention will now be described by reference to the following drawings wherein:

FIG. 1 is a flow chart of a PIN number modification system operating in accordance with the present invention; and

FIG. 2 is a schematic representation of a preferred PIN modification system operating in accordance with the present invention.

### DETAILED DESCRIPTION OF A PREFERRED EMBODIMENT

Various features of the present invention, as well as other objects and advantages attendant thereto, are set forth in the following description and the accompanying drawing in which like reference numerals depict like elements.

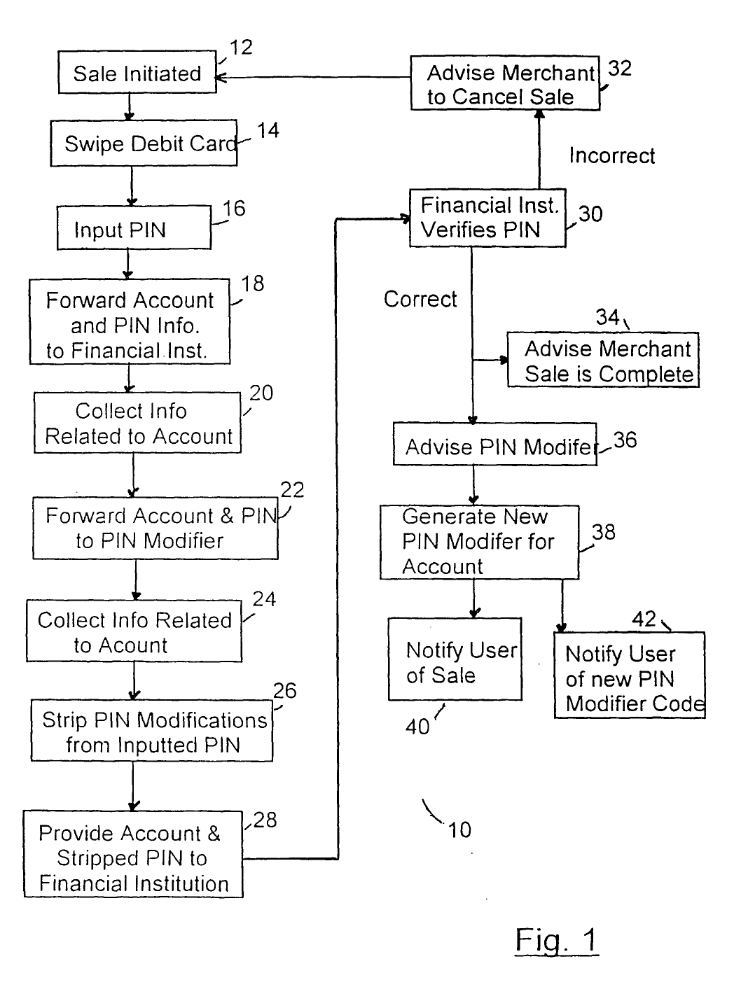

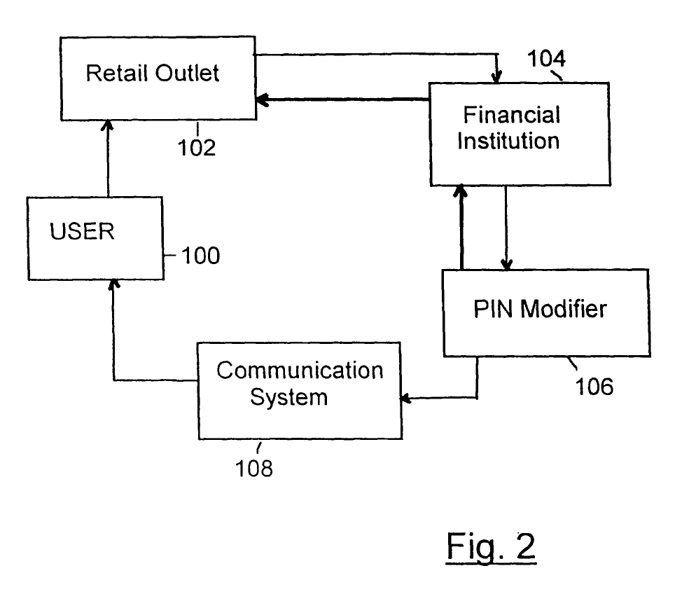

In FIG. 1, a flow chart of the actions and decisions made in a typical debit card transaction are shown. This should be read in conjunction with FIG. 2, which represents a typical arrangement of the various parties involved in the transaction.

In flow chart 10, the start of the process is the point where a customer purchases a product and opts to pay for the product with a debit card 12. The card is swiped to record the account number 14, and the purchaser inputs a modified PIN number 16, based on the standard PIN number and the PIN modifier code previously provided to the purchaser.

The account number and the modified PIN are provided electronically to a financial institution 18. In reality, there may be a series of financial institutions involved, but for brevity, only one is described. The financial institution locates its records related to the account number 20 to determine whether the purchaser is using a modified PIN number. For the purposes of this discussion, it is assumed that the purchaser is a client using the modified PIN number. If they were not, then the financial institution would merely verify the PIN number provided on their own.

The modified PIN number and the account number are then provided to a PIN number Modifier 22, which may, in fact be part of the financial institution, or may be a separate third party. The PIN Modifier then collects its information related to the account number 24, and in particular, determines the current PIN modification code for that account. In step 26, the PIN Modifier uses the PIN modification code to strip the added digits from the modified PIN, in order to provide a “stripped” PIN to the financial institution 28. The financial institution then compares the “stripped” PIN to the purchaser's standard PIN to verify that the correct standard PIN has been used as part of the modified PIN 30. If the stripped PIN is incorrect, the merchant is notified not to proceed with the transaction 32, and the purchaser and merchant can again attempt to initiate the transaction using the correct modified PIN. The financial institution can also advise the PIN Modifier of an incorrect PIN code entry, and the PIN Modifier can provide an “alert” to the purchaser that an unsuccessful attempt to use the card was made (not shown). If the authorized user has not made the attempt, they can then take steps to notify the financial institution that unauthorized use of the card is being attempted.

If the stripped PIN and the standard PIN agree, the financial institution advises the merchant that the sale has been successfully completed 34, and can advise the PIN Modifier of a successful transaction 36. The PIN Modifier will then select a new, preferably random, modifier code 38, and provide the new modifier code to the user 40. Optionally, the PIN Modifier can also advise the user of a successful transaction 42, which again, the user can verify as an authorized use of the debit card.

The schematic drawing of FIG. 2 merely shows a user 100 providing account and modified PIN information to a retail outlet 102, who then provides that information to the Financial Institution 104, which then provides the information to the PIN Modifier system 106, in accordance with the discussion of FIG. 1. The PIN Modifier uses a system, denoted as 108, in order to provide communications to the user 100, through an Internet-enabled cellular telephone.

Thus, it is apparent that there has been provided, in accordance with the present invention, a enhanced PIN number authorization system which fully satisfies the means, objects, and advantages set forth hereinbefore. Therefore, having described specific embodiments of the present invention, it will be understood that alternatives, modifications and variations thereof may be suggested to those skilled in the art, and that it is intended that the present specification embrace all such alternatives, modifications and variations as fall within the scope of the appended claims.

Additionally, for clarity and unless otherwise stated, the word “comprise” and variations of the word such as “comprising” and “comprises”, when used in the description and claims of the present specification, is not intended to exclude other additives, components, integers or steps.

We claim:

1. An enhanced method for verifying the identification of an authorized user of a set of protected resources within an employed system during a transaction, by utilizing a password, a passcode or a personal identification number, hereinafter collectively referred to as a PIN number, comprising:
providing a user with access to a set of protected resources through an account number;
establishing a standard PIN number related to said account number to limit access to said protected resources to only an authorized user;
providing said user with at least one PIN modifier code through an information transmission device;
creating a correct modified PIN number by applying said PIN modifier code to said standard PIN number;
verifying the authenticity of a PIN number entered when said user attempts to gain access to said set of protected resources in order to conduct a transaction by removing said PIN modifier code from the entered PIN number in order to created an entered, standard PIN number;
authorizing said transaction if said entered, standard PIN number agrees with said standard PIN number, and thus establishing that a successftil transaction attempt has been completed;
amending said PIN modifier code after a successful transaction attempt has been completed to a new PIN modifier code; and,
providing said user, when necessary, with at least one new PIN modifier code, through said information transmission device, for use in subsequent transaction attempts.

2. A method as claimed in claim 1 wherein said account number is stored on a system separate from said information transmission device.

3. A method as claimed in claim 2 wherein said account number is stored on a debit card, a credit card, a bank card, an ATM card, a prepaid card, or a smart card.

4. A method as claimed in claim 3 wherein said account number is stored on a debit card.

5. A method as claimed in any one of claims 1 to 4 wherein said standard PIN number comprises at least 4 digits.

6. A method as claimed in any one of claims 1 to 4 wherein said information transmission device is a telephone, an electronic messaging system, or a device which can gain access to an Internet connection, an interactive voice response application, or a short messaging service.

7. A method as claimed in claim 6 wherein said information transmission device is an Internet-enabled device.

8. A method as claimed in claim 6 wherein said information transmission device is an Internet-enabled cellular telephone.

9. A method as claimed in any one of claims 1 to 4 wherein said user is provided with only one PIN modifier code after each successful transaction.

10. A method as claimed in any one of claims 1 to 4 wherein said user is provided with a set of two or more PIN modifier codes after all previously provided PIN modifier codes have been successfully used.

11. A method as claimed in any one of claims 1 to 4 wherein said PIN modifier code is an instruction to add at least one character to said standard PIN number.

12. A method as claimed in claim 11 wherein said PIN modifier code is provided with instructions to add said character or characters to the beginning (“B”), middle (“M”) or end (“E”) of the standard PIN number, in accordance with a predetermined modification system.

13. A method as claimed in any one of claims 1 to 4 wherein said user is provided with an alert alter any transaction attempt.

14. A method as claimed in claim 13 wherein said alert is provided through said information transmission device.

15. A method as claimed in any one of claims 1 to 4 wherein said protected resource comprises a financial account of the user.

16. An enhanced system for verifying the identification of an authorized user of a set of protected resources within an employed system during a transaction comprising:
an account number reader for reading an account number;
a PIN number reader for reading an inputted PIN number;
a system for relating said PIN number to said account number to determine whether a correct PIN number has been entered into said reader; and
a PIN number modification system comprising:
a PIN modifier code generator which provides a PIN modifier code to said user through an information transmission device in order to create a modified PIN number;
a PIN number adjuster to remove the effects of said PIN modifier code from said inputted PIN number to generate an entered, standard PIN number;
a PIN number verifier to compare said entered, standard PIN number to a standard PIN number associated with said account number, and to confirm whether said entered, standard PIN number is the same as said standard PIN number, and thus, authorizing user to conduct said transaction.

17. An enhanced system as claimed in claim 16 wherein said PIN modifier code generator provides said user with a new PIN modifier code after each successful transaction.
